(19) United States
(12) Patent Application Publication
(10) Pub. No.: US 2009/0241292 A1
(43) Pub. Date: Oct. 1, 2009

(54) HINGE ASSEMBLY AND COMPUTER HOUSING USING THE SAME

(75) Inventors: JIN-XIN WANG, Shenzhen City (CN); HAN-ZHENG ZHANG, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/177,117

(22) Filed: Jul. 21, 2008

(30) Foreign Application Priority Data
Apr. 1, 2008 (CN) 200810300810.3

(51) Int. Cl. E05D 5/02; E05D 7/10

(52) U.S. Cl. 16/387; 16/221

(57) ABSTRACT

A hinge assembly includes a first connecting member, a second connecting member, a third connecting member, and a fourth connecting member. One end of the second connecting member is slidably connected to the first connecting member and the other end is rotatably connected to the fourth connecting member. The second connecting member is rotatably connected to the third connecting member. One end of the third connecting member is slidably connected to the fourth connecting member and the other end rotatably connected to the first connecting member.

### BACKGROUND OF THE INVENTION

1. Field of the Invention

The present invention relates to a hinge assembly and a computer housing the same.

2. Discussion of the Related Art

A typical computer housing includes a rear cover and a front cover. The rear cover includes a base and four sidewalls extending from the base. The base and the four sidewalls cooperatively define an opening. The front cover is attached to a top portion of the four sidewalls to seal the opening and protect the electronic components received in the base, such as a motherboard

Most front covers are fixed to rear covers with screws. A specialized instrument, such as a screwdriver, is required to disengage the front cover from the rear cover. Otherwise, without the specialized instrument, disengaging the front cover from the rear cover is complex and difficult.

Therefore, a new computer housing is desired to overcome the above-described shortcomings.

### SUMMARY

A hinge assembly includes a first connecting member, a second connecting member, a third connecting member, and a fourth connecting member. One end of the second connecting member is slidably connected to the first connecting member and the other end is rotatably connected to the fourth connecting member. The second connecting member is rotatably connected to the third connecting member. One end of the third connecting member is slidably connected to the fourth connecting member and the other end rotatably connected to the first connecting member.

Other advantages and novel features will become more apparent from the following detailed description of various embodiments, when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present hinge assembly and computer housing the same. Moreover, in the drawings, like reference numerals designate corresponding parts throughout several views, and all the views are schematic.

FIG. 1 is a partially assembled view of an embodiment of a computer housing comprising a cover, a main body, and a hinge assembly.

FIG. 2 is a side view of the hinge assembly of the computer housing of FIG. 1.

FIG. 3 is an exploded, isometric view of the hinge assembly of FIG. 2.

FIG. 4 is an assembled, isometric view of the hinge assembly of FIG. 2 in a configuration when the cover of the computer housing is closed.

FIG. 5 is an assembled, isometric view of the hinge assembly of FIG. 4, but viewed from another aspect.

### DETAILED DESCRIPTION OF THE EMBODIMENTS

Reference will now be made to the drawings to describe embodiments of a hinge assembly and a computer housing the same in detail.

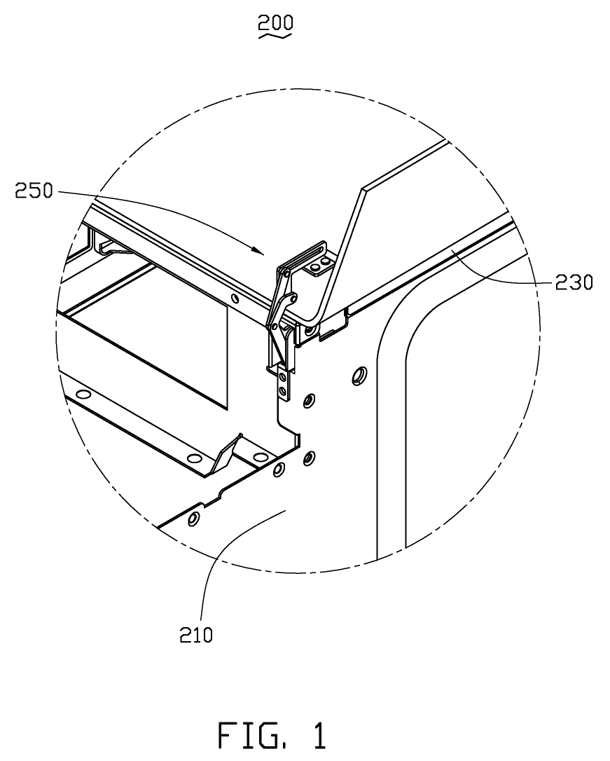

Referring to FIG. 1, an embodiment of a computer housing 200 includes a main body 210, a cover 230, and a hinge assembly 250. The cover 230 is rotatably attached to the main body 210 via the hinge assembly 250.

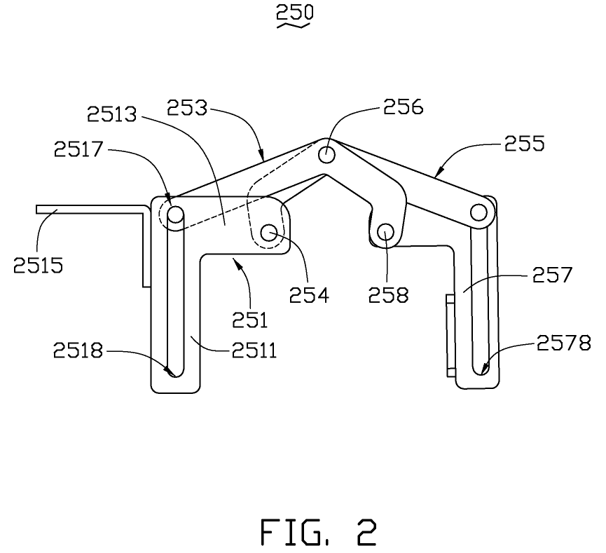

Referring to FIG. 2, the hinge assembly 250 includes a first connecting member 251, a second connecting member 253, a third connecting member 255, a fourth connecting member 257, a first rivet 254, a second rivet 256, and a third rivet 258.

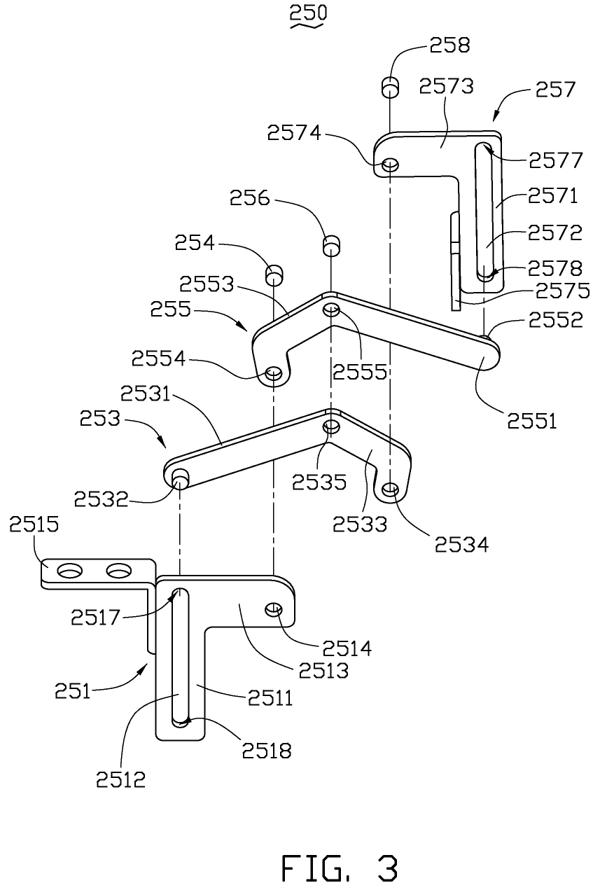

Referring also to FIG. 3, the first connecting member 251 includes a sliding portion 2511, a resisting portion 2513 extending from a side of the sliding portion 2511, and a connecting portion 2515 formed on another side of the sliding portion 2511 opposite to the resisting portion 2513. The sliding portion 2511 defines a guide slot 2512. The resisting portion 2513 defines a pivot hole 2514. The connecting portion 2515 is configured for connecting to the main body 210.

The second connecting member 253 includes a sliding portion 2531 and a resisting portion 2533 extending from a side of the sliding portion 2531. The sliding portion 2531 forms a pivot shaft 2532. The resisting portion 2533 defines a pivot hole 2534. A corner between the sliding portion 2531 and the resisting portion 2533 also defines a pivot hole 2535. The pivot shaft 2532 is configured to engage in the guide slot 2512 and slide relative to the guide slot 2512.

The third connecting member 255 includes a sliding portion 2551 and a resisting portion 2553 extending from a side of the sliding portion 2551. The sliding portion 2551 forms a pivot shaft 2552. The resisting portion 2553 defines a pivot hole 2554. A corner between the sliding portion 2551 and the resisting portion 2553 also defines a pivot hole 2555.

The fourth connecting member 257 includes a sliding portion 2571, a resisting portion 2573 extending from a side of the sliding portion 2571, and a connecting portion 2575 formed on another side of the sliding portion 2571 opposite to the resisting portion 2573. The sliding portion 2571 defines a guide slot 2572. The resisting portion 2573 defines a pivot hole 2574. The connecting portion 2575 is configured for connecting to the cover 230.

To assemble the computer housing 200, following steps are provided.

The second connecting member 253 is fixably attached to the first connecting member 251. The pivot shaft 2532 is inserted into the guide slot 2512 such that the sliding portion 2531 slides along the guide slot 2512, and the second connecting member 253 rotates at the pivot shaft 2532.

The third connecting member 255 is fixably attached to the first connecting member 251 via the first rivet 254 passing through the pivot holes 2554, 2514 such that the resisting portion 2553 is slidably connected to the resisting portion 2513. A portion of the first rivet 254 between the resisting portions 2513, 2553 forms a restriction portion (not shown) to restrict the range of motion of the second connecting member 253.

The third connecting member 255 is fixably attached to the second connecting member 253 via a second rivet 256 passing through the pivot holes 2535, 2555 such that the second connecting member 253 and the third connecting member 255 are rotatable relative to the second rivet 256.

The fourth connecting member 257 is fixably attached to the third connecting member 255. The pivot shaft 2552 is inserted into the guide slot 2572 such that the sliding portion 2551 slides along the guide slot 2572 of the sliding portion 2571, and the sliding portion 2551 rotates at the pivot shaft 2552.

The fourth connecting member 257 is fixably attached to the second connecting member 253 via a third rivet 258 passing through the pivot holes 2574, 2534 in that order such that the second connecting member 253 and the fourth connecting member 257 are rotatable relative to the third rivet 258. A portion of the third rivet 258 between the resisting portions 2533, 2573 forms a restriction portion (not shown) to restrict the range of motion of the third connecting member 255.

The computer housing 200 as shown in FIG. 1 is assembled by connecting the connecting portion 2515 to the main body 210, and connecting the connecting portion 2575 to the cover 230. The hinge assembly 250 is located on an inner side of the cover 230.

In use, the cover 230 is rotated to open the computer housing 200 to allow components received in the main body 210 to be accessed conveniently.

In one embodiment, the hinge assembly 250 is positioned in a space defined by the cover 230 and the main body 210 such that the hinge assembly 250 is hidden from view outside the computer housing 200 when the cover 230 is closed.

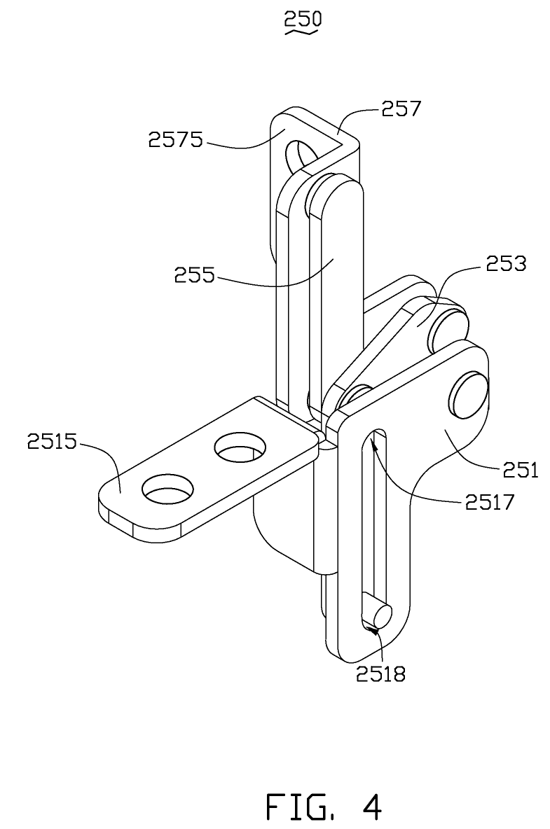

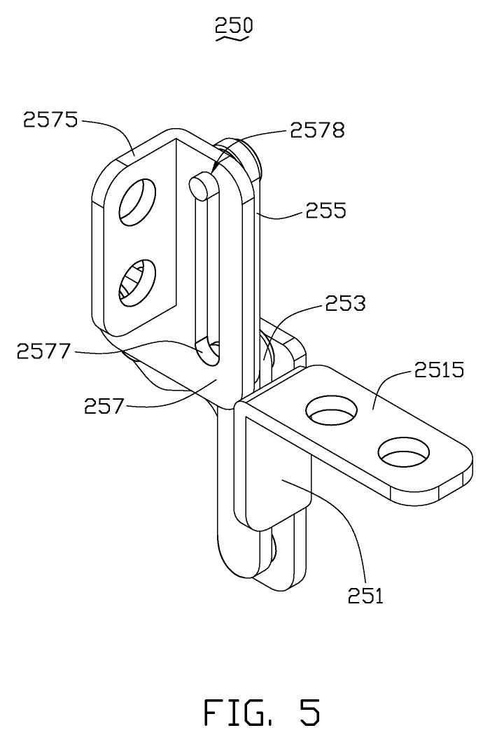

Referring to FIGS. 4 and 5, when the cover 230 is closed, the pivot shaft 2532 contacts a bottom end 2518 of the guide slot 2512 and the pivot shaft 2552 resists a bottom end 2578 of the guide slot 2572.

To open the cover 230, an external force is applied to the cover 230. The pivot shaft 2532 slides to a top end 2517 of the guide slot 2512, the second connecting member 253 rotates at the pivot shaft 2532 and drives the third connecting member 255 to rotate relative to the second rivet 256. In other words, when the second connecting member 253 slides, the second connecting member 253 rotates relative to the first connecting member 251 and the third connecting member 255.

When the second connecting member 253 and the third connecting member 255 rotate relative to the second rivet 256, the second connecting member 253 and the third connecting member 255 drive the fourth connecting member 257 to rotate relative to the second connecting member 253 and the third connecting member 255. In other words, the second connecting member 253 and the third connecting member 255 rotate relative to the fourth connecting member 257 at the third rivet 258 and the pivot shaft 2552 respectively.

When the fourth connecting member 257 rotates relative to the third connecting member 255 at a center of the pivot shaft 2552, the pivot shaft 2552 slides towards a top end 2577 of the guide slot 2572. After the pivot shaft 2532 slides to the top end 2517 of the guide slot 2512 and becomes restricted by the guide slot 2512 of the sliding portion 2511, the second connecting member 253 also moves to the restriction portion of the first rivet 254 and becomes restricted by the restriction portion of the first rivet 254.

The hinge assembly 250 remains a stable state when the pivot shaft 2552 slides to the top end 2577 of the guide slot 2572 and is restricted by the guide slot 2572, and the third connecting member 255 is restricted by the restriction portion of the third rivet 258.

When the cover 230 is opened, an angle defined by the cover 230 and the main body 210 can be adjusted by adjusting the lengths of the first connecting member 251, the second connecting member 253, the third connecting member 255, and the fourth connecting member 257.

In the illustrated embodiment, after the cover 230 is opened, the cover 230 is rotated 180 degrees and the cover 230 only bears a weight of the cover and a supporting force of the hinge assembly 250. Because a direction of the weight of the cover and a direction of the supporting force are in a same line, an angular moment that would easily damage the cover and/or the hinge assembly is eliminated. The cover 230 clings to a surface of the main body 210, so a small space is defined by the cover 230 and the main body 210.

To close the cover 230, another external force is manually applied to the cover 23, the pivot shaft 2552 slides to the bottom end 2578 and the pivot shaft 2532 slides to the bottom end 2518.

In one embodiment, the guide slot 2511 can be another configuration such as a slide rail. In another embodiment, the other connecting means can be applied to the first connecting member 251 and the second connecting member 253. For example, a cylindrical protrusion can be positioned on the second connecting member 253 such that an end of the cylindrical protrusion is fixed on the second connecting member 253 and another end of the cylindrical protrusion is inserted into the guide slot 2512. In another example, the connecting means of the first connecting member 251, the second connecting member 253, the third connecting member 255, and the fourth connecting member 257 can be replaced by a configuration of a cylindrical protrusion and a through hole.

In one embodiment, the fourth connecting member 257 of the hinge assembly 250 can be omitted along with the sliding portion 2551 of the third connecting member 255. In this configuration, the cover 230 can be fixed on the second connecting member 253 directly and the third connecting member 255 is used to restrict and fix the first connecting member 251 and the second connecting member 253.

In one embodiment, the restriction portion of the first rivet 254 and the restriction portion of the third rivet 258 are protrusions formed on the resisting portion 2513 and the resisting portion 2573, respectively. In another embodiment, if a distance from the pivot hole 2514 to the guide slot 2512 and a distance from the pivot hole 2554 to the pivot hole 2555 are greater than a distance from the pivot shaft 2532 to the pivot hole 2535, the restriction portion of the first rivet 254 can be omitted. Similarly, the restriction portion of the third rivet 258 can be omitted.

It may be appreciated that the hinge assembly 250 can be applied to other electronic devices such as medium players, fax machines, printers, and the windows of buildings and automobiles. The cover 230 can also be replaced by another foldable portion.

While various embodiments have been described and illustrated, the invention is not to be construed as being limited thereto. Various modifications can be made to the embodiments by those skilled in the art without departing from the true spirit and scope of the invention as defined by the appended claims.

What is claimed is:

1. A hinge assembly, comprising:
a first connecting member;
a second connecting member;
a third connecting member; and
a fourth connecting member,
wherein an end of the second connecting member being slidably connected to the first connecting member and another end of the second connecting member rotatably connected to the fourth connecting member, the second connecting member rotatably connected to the third connecting member, an end of the third connecting member being slidably connected to the fourth connecting member and another end of the third connecting member rotatably connected to the first connecting member; when the second connecting member slides relative to the first connecting member, the second connecting member rotates relative to the first connecting member, the third connecting member, and the fourth connecting member and drives the third connecting member to slide relative to the fourth connecting member; when the third connecting member slides relative to the fourth connecting member, the third connecting member rotates relative to the first connecting member, the second connecting member, and the fourth connecting member, and drives the second connecting member to slide relative to the first connecting member.

2. The hinge assembly of claim 1, wherein the first connecting member includes a sliding portion and a resisting portion extending from a side of the sliding portion of the first connecting member, the second connecting member includes a sliding portion and a resisting portion extending from a side of the sliding portion of the second connecting member, the third connecting member includes a sliding portion and a resisting portion extending from a side of the sliding portion of the third connecting member, the fourth connecting member includes a sliding portion and a resisting portion extending from a side of the sliding portion of the fourth connecting member, the sliding portion of the second connecting member is slidably connected to the sliding portion of the first connecting member, the sliding portion of the third connecting member is slidably connected to the sliding portion of the fourth connecting member, the resisting portion of the second connecting member is rotatably connected to the resisting portion of the fourth connecting member, the resisting portion of the third connecting member is rotatably connected to the resisting portion of the first connecting member, a corner of the sliding portion of the second connecting member and the resisting portion of the second connecting member is rotatably connected to a corner of the sliding portion of the third connecting member and the resisting portion of the third connecting member.

3. The hinge assembly of claim 2, wherein the sliding portion of the first connecting member defines a guide slot, the sliding portion of the second connecting member forms a protrusion, the protrusion is passed through the guide slot of the first connecting member such that the sliding portion of the second connecting member is slidably connected to the sliding portion of the first connecting member.

4. The hinge assembly of claim 3, wherein the hinge assembly further includes a first rivet, the resisting portion of the first connecting member defines a through hole, the resisting portion of the third connecting member define a through hole, the first rivet is passed through the through holes of the resisting portion of the first connecting member and the resisting portion of the third connecting member such that the third connecting member is rotatably connected to the first connecting member.

5. The hinge assembly of claim 4, wherein the hinge assembly further includes a second rivet, a corner of the sliding portion of the second connecting member and the resisting portion of the second connecting member and a corner of the sliding portion of the third connecting member and the resisting portion of the third connecting member define through holes respectively, the second rivet is passed through the through holes of the corner of the sliding portion of the second connecting member and the resisting portion of the second connecting member and the corner of the sliding portion of the third connecting member and the resisting portion of the third connecting member such that the third connecting member is rotatably connected to the second connecting member.

6. The hinge assembly of claim 5, wherein the sliding portion of the fourth connecting member defines a guide slot, the sliding portion of the third connecting member forms a protrusion, the protrusion of the sliding portion of the third connecting member is passed through the guide slot of the sliding portion of the fourth connecting member such that the sliding portion of the third connecting member is slidably connected to the sliding portion of the fourth connecting member.

7. The hinge assembly of claim 5, wherein the hinge assembly further includes a third rivet, the resisting portion of the second connecting member and the resisting portion of the fourth connecting member define through holes respectively, the third rivet is passed through the through holes of the resisting portion of the second connecting member and the resisting portion of the fourth connecting member such that the second connecting member is rotatably connected to the fourth connecting member.

8. The hinge assembly of claim 2, wherein the resisting portion of the first connecting member forms a restriction portion configured for restricting the second connecting member, the resisting portion of the fourth connecting member forms a restriction portion configured for restricting the third connecting member.

9. A computer housing, comprising:
a main body;
a foldable portion; and
a hinge assembly connecting the foldable portion to the main body;
wherein the hinge assembly includes a first connecting member, a second connecting member, a third connecting member, and a fourth connecting member, an end of the second connecting member is slidably connected to the first connecting member and another end of the second connecting member is rotatably connected to the fourth connecting member, the second connecting member is rotatably connected to the third connecting member, an end of the third connecting member is slidably connected to the fourth connecting member and another end of the third connecting member is rotatably connected to the first connecting member; when the second connecting member slides relative to the first connecting member, the second connecting member rotates relative to the first connecting member, the third connecting member, and the fourth connecting member, and drives the third connecting member slides relative to the fourth connecting member; when the third connecting member slides relative to the fourth connecting member, the third connecting member rotates relative to the first connecting member, the second connecting member, and the fourth connecting member, and drives the second connecting member to slide relative to the first connecting member.

10. The computer housing of claim 9, wherein the first connecting member includes a sliding portion and a resisting portion extending from a side of the sliding portion of the first connecting member, the second connecting member includes a sliding portion and a resisting portion extending from a side of the sliding portion of the second connecting member, the third connecting member includes a sliding portion and a resisting portion extending from a side of the sliding portion of the third connecting member, the fourth connecting member includes a sliding portion and a resisting portion extending from a side of the sliding portion of the fourth connecting member, the sliding portion of the second connecting member is slidably connected to the sliding portion of the first contacting member, the sliding portion of the third connecting member is slidably connected to the sliding portion of the fourth connecting member, the resisting portion of the second connecting member is rotatably connected to the resisting portion of the fourth connecting member, the resisting portion of the third connecting member is rotatably connected to the resisting portion of the first contacting member, a corner of the sliding portion of the second connecting member and the resisting portion of the second connecting member is rotatably connected to a corner of the sliding portion of the third connecting member and the resisting portion of the third connecting member.

11. The computer housing of claim 10, wherein the sliding portion of the first connecting member defines a guide slot, the sliding portion of the second connecting member forms a protrusion, the protrusion is passed through the guide slot of the first connecting member such that the sliding portion of the second connecting member is slidably connected to the sliding portion of the first connecting member.

12. The computer housing of claim 11, wherein the hinge assembly further includes a first rivet, the resisting portion of the first connecting member and the resisting portion of the third connecting member define through holes, the first rivet is passed through the through holes of the resisting portion of the first connecting member and the resisting portion of the third connecting member such that the third connecting member is rotatably connected to the first connecting member.

13. The computer housing of claim 12, wherein the hinge assembly further includes a second rivet, a corner of the sliding portion of the second connecting member and the resisting portion of the second connecting member and a corner of the sliding portion of the third connecting member and the resisting portion of the third connecting member define through holes respectively, the second rivet is passed through the through holes of the corner of the sliding portion of the second connecting member and the resisting portion of the second connecting member and the corner of the sliding portion of the third connecting member and the resisting portion of the third connecting member such that the third connecting member is rotatably connected to the second connecting member.

14. The computer housing of claim 13, wherein the sliding portion of the fourth connecting member defines a guide slot, the sliding portion of the third connecting member forms a protrusion, the protrusion of the sliding portion of the third connecting member is passed through the guide slot of the sliding portion of the fourth connecting member such that the sliding portion of the third connecting member is slidably connected to the sliding portion of the fourth connecting member.

15. The computer housing of claim 14, wherein the hinge assembly further includes a third rivet, the resisting portion of the second connecting member and the resisting portion of the fourth connecting member define through holes respectively, the third rivet is passed through the through holes of the resisting portion of the second connecting member and the resisting portion of the fourth connecting member such that the second connecting member is rotatably connected to the fourth connecting member.

16. The computer housing of claim 10, wherein the resisting portion of the first connecting member forms a restriction portion configured for restricting the second connecting member, the resisting portion of the fourth connecting member forms a restriction portion configured for restricting the third connecting member.
